(19) United States
(12) Patent Application Publication
(10) Pub. No.: US 2008/0304440 A1
(43) Pub. Date: Dec. 11, 2008

(54) Terminal and Method for Accessing Wireless Connection

(75) Inventors: Sun-Mi Jun, Daejeon-city (KR); Nam-Hoon Park, Daejeon-city (KR)

Correspondence Address: Jefferson IP Law, LLP, 1730 M Street, NW, Suite 807, Washington, DC, 20036, US

(73) Assignees: ELECTRONICS AND TELECOMMUNICATIONS RESEARCH INSTIT, Daejeon (KR); SAMSUNG ELECTRONICS CO., LTD., Gyeonggi-do (KR); KT CORPORATION, Kyeongki-do (KR); SK TELECOM CO., LTD., Seoul (KR); KTFREETEL CO., LTD., Seoul (KR); HANARO TELECOM, INC., Seoul (KR)

(21) Appl. No.: 11/721,436

(22) PCT Filed: Nov. 16, 2005
(86) PCT No.: PCT/KR05/03873

§ 371 Date: Jun. 11, 2007

(30) Foreign Application Priority Data
Dec. 14, 2004 (KR) 10-2004-0105593

(51) Int. Cl. H04Q 7/00; H04L 27/28

(52) U.S. Cl. 370/328; 375/260

(57) ABSTRACT

A method for establishing a wireless connection performed by a subscriber station (SS) to receive Internet services from a given terminal node through a base station (BS), the method including: a) when an initial connection with the BS is established, establishing a first MAC connection with the BS, and setting the first MAC connection as a dedicated TCP connection; b) when a given packet is generated, the SS determining whether the given packet is a control packet for a TCP connection with the SS; c) transmitting the given packet through the dedicated TCP connection when a control packet is transmitted, and establishing a TCP connection with the SS; d) after establishing the TCP connection, establishing a second MAC connection for data communication between the SS and the BS; and e) after establishing the TCP connection and the second MAC connection, receiving data from the SS through the second MAC connection.

### TECHNICAL FIELD

The present invention relates to a mobile communication system. More particularly, the present invention relates to a mobile terminal and a method for accessing a wireless connection performed by the mobile terminal for receiving Internet services in a wireless portable Internet system.

### BACKGROUND ART

In a mobile communication system, a portable Internet system is the next generation communication system that supports mobility to a local area data communication system that uses a fixed access point such as a local area network (LAN).

The world wide web (WWW) is the most poplar Internet service provided by the portable Internet system. A Transmission Control Protocol/internet Protocol (TCP/IP) connection should be established in order to use Internet services. Mechanisms for such a TCP/IP connection are as described below.

Most web sites have a server process listening to TCP port 80 for incoming connection from clients (normally, browsers). After establishment of a TCP connection between a server and a client, the client transmits a hypertext transfer protocol (HTTP) request for a document to the server. The server, in turn, transmits an HTTP response, defines a hypertext transfer protocol (HTTP), and transmits a web document. However, since a TCP session involves one round-trip message exchange (an HTTP request and an HTTP response), a process for opening and closing a new TCP session is iteratively performed whenever the messages are exchanged.

A process for downloading a web page using an HTTP on a time division multiple access (TDMA)-based general packet radio service (GPRS) requires a TCP connection and a wireless link layer connection. Thus, a process for establishing and releasing a media access control (MAC) by controlling the wireless link is performed when a process for establishing and releasing the TCP connection is performed. That is, a TCP connection should be established to download one hypertext markup language (HTML) document, but, at this point, a wireless MAC connection should be established before establishing the TCP connection. To establish the wireless MAC connection, a wireless link is set and the TCP connection is established by a TCP signaling packet.

The following is a process for establishing and releasing a TCP connection in terms of the IEEE802.16 MAC standard in the portable internet system. When a TCP:SYN packet is transmitted for establishing a TCP connection from a client to a MAC layer which is a wireless link layer, a MAC connection is established on a wireless link. A TCP connection with a target server in the Internet is established when a wireless connection is open. A TCP connection is established between the client and the server when the server transmits a TCP:ACK packet to the client in response to the TCP:SYN packet, and the client in turn transmits a TCP:ACK packet to the server through the wireless connection. Once the TCP connection is established, the client sends an HTTP request for a desired file, and the server downloads the requested file as an HTTP response. When a file transmission process is completed, a process for releasing the TCP connection needs to be performed. At this point, a process for releasing the wireless MAC connection also needs to be performed. In other words, after the process for releasing the TCP connection on the wireless link is successfully performed, the wireless MAC connection must be released in order to completely shut down the TCP connection.

To establish/release a TCP connection, the client must exchange TCP control packets (e.g., SYN, FIN, and so on) with a communication node at a target side through the TCP connection. Although the connection is established and traffic is downloaded from the target side, the communication node must receive a TCP packet reporting a download TCP connection state and packet acknowledgement through an uplink from the client. In this instance, quality of an end-user service may be improved when the TCP packet is transmitted at a high rate through a reliable link. Poor performance of TCP packet transmission causes unstable TCP control and frequent packet retransmission, and as a result, it degrades Internet service performance.

In addition, since a process of establishing/releasing a MAC connection must be accompanied by a signaling packet transmission through a wireless connection when using a TCP/IP-based Internet, the connection may be frequently established and released while causing a delay, thereby degrading quality of service. The MAC connection may be maintained without using a radio resource for the purpose of reducing costs consumed for establishing/releasing the MAC connection, but it may decrease usability of radio resources.

Therefore, an appropriate method for managing a connection of a connection-oriented MAC such as the IEEE 802.16 MAC is needed in order to efficiently use radio resources in consideration of characteristics of a target service.

The above information disclosed in this Background section is only for enhancement of understanding of the background of the invention and therefore it may contain information that does not form the prior art that is already known in this country to a person of ordinary skill in the art.

### DISCLOSURE OF INVENTION

### Technical Problem

The present invention has been made in an effort to provide a method for establishing an efficient connection to a wireless link layer in consideration of characteristics of TCP control packets transmitting/receiving incurred in consequence to a use of TCP/IC-based Internet in a portable Internet system to thereby efficiently use radio resources.

### Technical Solution

In one aspect of the present invention, there is provided a method for establishing a wireless connection performed by a subscriber station to receive Internet services from a given terminal node through a base station. The method includes a) when an initial connection with the base station is established, establishing a first medium access control (MAC) connection between the base station, and setting the first MAC connection as a dedicated connection; b) when a given packet is generated, the subscriber station determining whether the given packet is a control packet for transmission Control Protocol (TCP) connection with the terminal node; c) when the given packet is the control packet, transmitting the given packet through the dedicated TCP connection and establishing a TCP connection with the terminal node; d) after establishing the TCP connection, establishing a second MAC connection for data communication between the terminal node and the base station; and e) after establishing the TCP connection and the second MAC connection, receiving data from the terminal node through the second MAC connection.

The second MAC connection is a communication connection established after establishment of the dedicated TCP connection, and may be provided more than one.

In another aspect of the present invention, there is provided a subscriber station establishing a wireless connection to receive Internet services from a base station through a given terminal node in a wireless portable Internet system. The subscriber station includes a Medium Access Control (MAC) connection, a packet generator, and a packet classifying unit. The Medium Access Control (MAC) connection processing unit establishes a first MAC connection with the base station and sets the connection as a dedicated TCP connection when an initial connection with the base station is established. The packet generator generates a control packet for a TCP connection with the base station and a response packet in response to a given packet received at the subscriber station. The packet classifying unit analyzes a header of a packet transmitted from the packet generator and determining whether the packet is a control packet for a TCP connection, and transmitting the packet to the base station through the dedicated TCP connection when the packet is a control packet.

### ADVANTAGEOUS EFFECTS

According to the present invention, a wireless link is established and released while considering characteristics of TCP/IP-based services in a MAC layer of a terminal such that radio resources are efficiently managed and time delay due to the wireless link establishment may be reduced. As a result, usability for an end-user is increased.

In addition, since a terminal determines a TCP session and manages a wireless link, a load of a base station may be reduced.

### BRIEF DESCRIPTION OF THE DRAWINGS

FIG. 1 is a schematic diagram of a wireless portable Internet system according an exemplary embodiment of the present invention.

FIG. 2 is a hierarchical diagram of a wireless portable Internet system.

FIG. 3 is a schematic diagram of a connection structure between a base station and a subscriber station in a wireless portable Internet system.

FIG. 4 is a configuration diagram of a subscriber station according to an exemplary embodiment of the present invention.

FIG. 5 is a flowchart of a process establishing a connection between a base station and a subscriber station according to an exemplary embodiment of the present invention.

FIG. 6 is a flowchart of a process establishing a TCP connection according to an exemplary embodiment of the present invention.

FIG. 7 is a flowchart of a wireless connection method according to an exemplary embodiment of the present invention.

FIG. 8 is a flowchart of a process establishing a TCP connection and a MAC connection according to an exemplary embodiment of the present invention.

FIG. 9 is a flowchart of a process terminating a TCP connection and a MAC connection according to an exemplary embodiment of the present invention.

### BEST MODE FOR CARRYING OUT THE INVENTION

An embodiment of the present invention will hereinafter be described in detail with reference to the accompanying drawings.

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive.

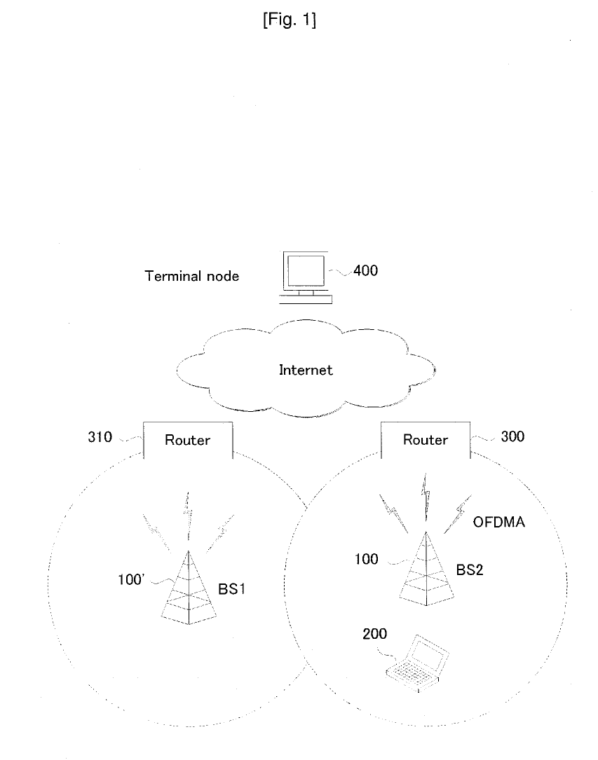

FIG. 1 schematically shows a structure of a wireless portable Internet system according to an exemplary embodiment of the present invention.

The wireless portable Internet system includes base stations 100 and 100′, a subscriber station 200, which is a mobile terminal wirelessly communicating with the base stations, routers 300 and 310 connected to the base stations 100 and 100′ through a gateway, and the Internet. Throughout embodiments of the present exemplary embodiment, a mobile terminal will be called a subscriber station for ease of description.

When the subscriber station 200 moves from one cell covered by the base station 100 to another cell covered by the base station 100′, the wireless portable Internet system guarantees mobility to provide seamless data communication services and supports a handover of the subscriber station 200 as a mobile communication service does. This system also performs dynamic IP address allocation corresponding to the movement of the subscriber station 200.

The subscriber station 200 and the base stations 100 and 100′ may communicate with each other using an orthogonal frequency division multiplexing access (OFDMA) method, but it is not restricted thereto. The OFDMA method is a multiplexing method combining frequency division multiplexing (TDM) using a plurality of orthogonal frequency sub-carriers as a plurality of sub-channels, and time division multiplexing (TDM). The OFDMA method generically has advantages of resisting multipath fading while having high-rate data transmission.

The IEEE 802.16e standard employs an adaptive modulation and coding (AMC) scheme that adaptively selects modulation and coding upon a request/accept between the subscriber station 200 and a base stations 100 or 100′.

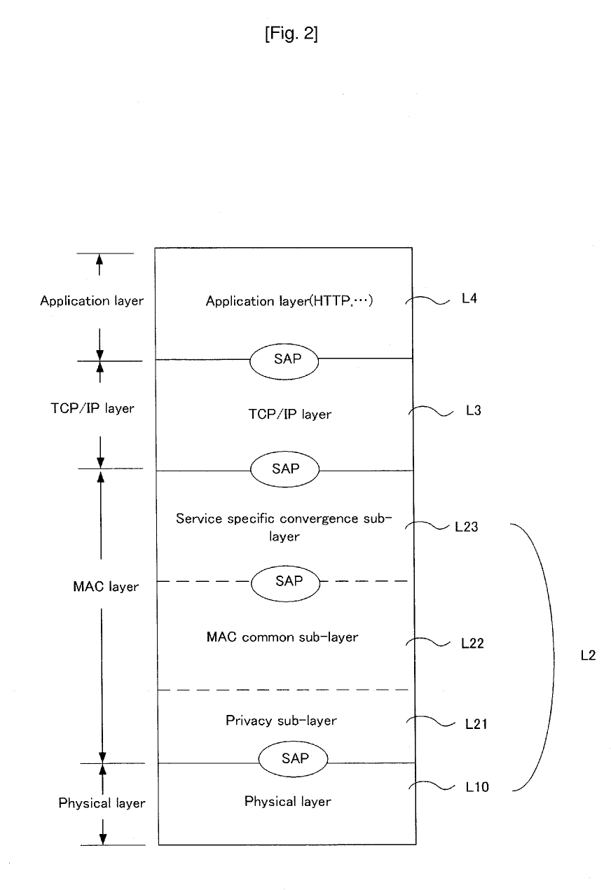

FIG. 2 is a hierarchical diagram of a wireless portable Internet system according to an exemplary embodiment of the present invention.

A hierarchy structure of the wireless portable Internet system is broadly divided into a physical layer L1, a Medium Access Control (MAC) layer L2, a Transmission Control Protocol/Internet Protocol (TCP/IP) layer L3, and an application layer L4, in terms of HTTP and IEEE 802.16e standards.

The physical layer L10 performs wireless communication functions (e.g., modulation/demodulation and coding, etc.) similar to a typical physical layer. The physical layer L1 includes a transmitting/receiving apparatus such as a modem converting data for the purpose of data protection in a wireless environment, and a radio frequency (RF) unit transmitting data over the air.

Unlike a wired Internet system having function-specific layers, the MAC layer in the wireless portable Internet system performs various functions. Therefore, the MAC layer L2 may include function-specific sub-layers, i.e., a privacy sub-layer L21, a MAC common part sub-layer L22, and a service specific convergence sub-layer L23.

The service specific convergence sub-layer L23 performs payload header suppression and Quality of Service (QoS) mapping in the case of consecutive data communication. In particular, it manages a MAC connection, and classifies and processes TCP packets transmitted thereto according to an exemplary embodiment of the present invention.

The MAC common part sub-layer L22, which is the core part of the MAC layer, performs system access, bandwidth allocation, connection establishment and maintenance, and QoS management.

The privacy sub-layer L21 performs device authentication, security key exchange, and encryption. Device authentication is performed by the privacy sub-layer L21, and user authentication is performed by an upper layer of the MAC layer.

The TCP/IP layer L3 connects each system and transmits data using a TCP protocol, and the application layer L4 includes an application program using a network.

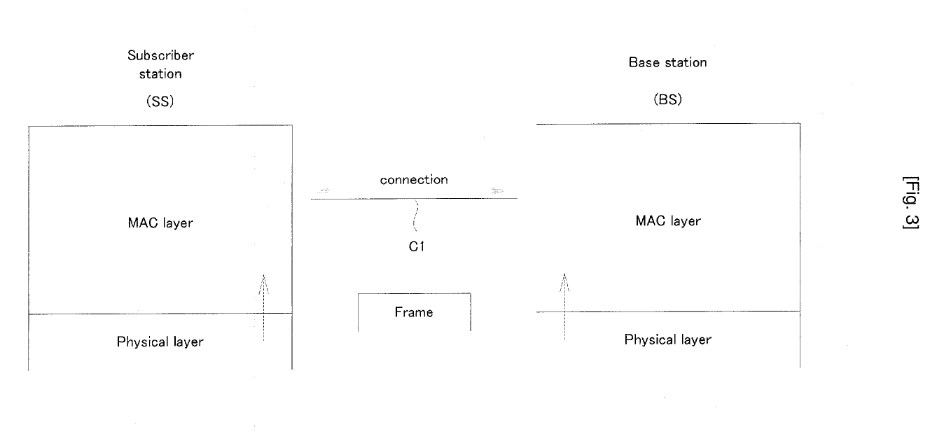

FIG. 3 is a schematic diagram of a connection established between a base station and a subscriber station in the wireless portable Internet system according to an exemplary embodiment of the present invention.

A MAC layer of the subscriber station (SS) and a MAC layer of the base station (BS) have a connection C1 established therebetween. Herein, the term “connection C1” represents a logical relation rather than a physical relation, and it is defined on the connection C1 to be a mapping relation between MAC peers of the SS and the BS for traffic transmission of one service flow in the present invention.

Therefore, parameters or messages as defined with respect to the connection C1 represent the functions between the MAC peers, and in reality, the parameters or the messages are processed and converted into frames in order to be transmitted through a physical layer. The MAC layer performs functions corresponding to the parameters or messages by parsing the frames. A MAC message transmitted through the connection C1 basically includes a connection identifier, which is a MAC layer address, for identifying connections; radio resource allocation information (MAP) defining symbol offsets and sub-channel offsets of bursts, and the number of symbols and sub-channels of allocated resources, the burst being divided by the SS in a downlink/uplink; and a channel descriptor for describing characteristics of the physical layer according to characteristics of the downlink/uplink (a downlink channel descriptor and an uplink channel descriptor will be referred to as DCD and UCD, respectively). In addition, the MAC message includes various messages for a request, a response, and an acknowledgement, etc.

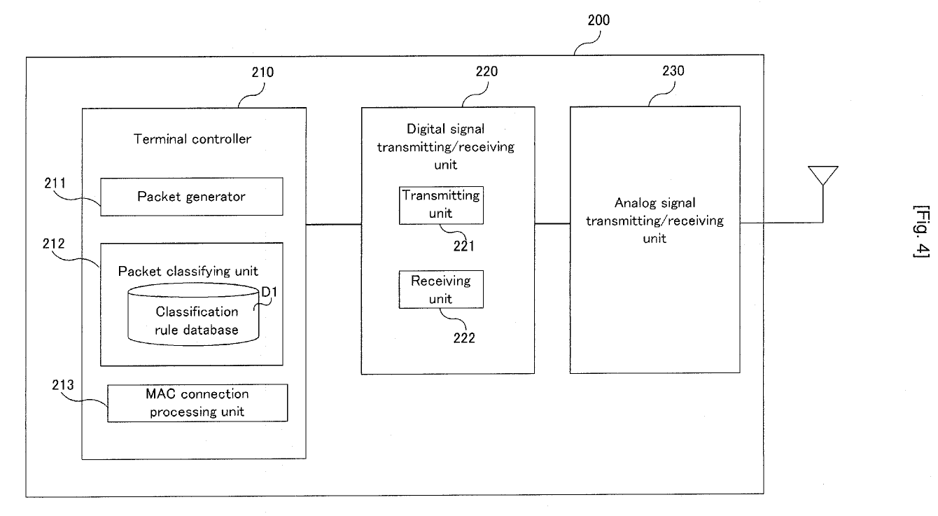

FIG. 4 illustrates a structure of the subscriber station in the wireless portable Internet system having the above-described hierarchical layer.

As shown in FIG. 4, the SS 200 includes a terminal controller 210, a digital signal transmitting/receiving unit 220, and an analog signal transmitting/receiving unit 230.

The terminal controller 210 includes a packet generator 211, a packet classifying unit 212 analyzing and classifying generated packets, and a MAC connection processor establishing a wireless MAC connection according to a packet.

The packet generator 211 generates packets necessary for keeping data transmitting/receiving with the BS 100. In particular, it generates a plurality of TCP control packets for data transmitting/receiving while taking account of a TCP. Such a packet generator 211 is included in the application layer L4 of FIG. 2.

The packet classifying unit 212 analyzes a packet header provided from the packet generator 211 to determine the type of a packet, and controls the MAC connection processor 213 to establish a wireless uplink connection according to an analyzing result. In particular, the packet classifying unit 212 controls the MAC connection processor 213 to establish a connection dedicated for TCP control packet transmission between the SS and the uplink according to an exemplary embodiment of the present invention. Such a connection dedicated for the TCP control packet transmission is called “a dedicated TCP connection.”

Thus, when a packet provided by the packet generator 211 is discriminated as a TCP control packet, the packet is transmitted through the dedicated TCP connection. The dedicated TCP connection is maintained until the connection established between the SS and the BS is shut down.

The packet classifying unit 212 further includes a classification rule database D1 for mapping a given connection according to a destination address, a source address, and a communication port of a given traffic packet, and storing a mapping result. The packet classifying unit 212 maps the given traffic packet to a given connection according to information containing a destination address or a communication port of a given packet stored in the classification rule database D1.

The MAC connection processor 213 establishes a wireless connection for uplink data transmitting/receiving. Thus, the MAC connection processor 213 transmits a request message (DSA_REQ) to the BS 100 for a MAC connection, receives a response message (DSA_RSP) from the BS 100 in response to the request message, and establishes the requested MAC connection with the BS 100.

The packet classifying unit 212 and the MAC connection processor 213 are included in the service specific convergence sublayer L23. Accordingly, a signal output from the packet classifying unit 212 and the MAC connection processor 213 is transmitted to the MAC layer of the BS 100 via the MAC common part sublayer L22 and the privacy sublayer L21 of the MAC layer L2, and through the physical layer L10.

The terminal controller 210 may further include a plurality of devices for transmitting/receiving data and processing data apart from the above-described elements according to an embodiment of the present invention, and detailed description of the devices will not be provided since they are well known to those skilled in the art.

The digital transmitting/receiving units 120 and 220 and the analog transmitting/receiving units 130 and 230 are included in the physical layer L10, and detailed description of these units will not be provided since they are well known to those skilled in the art.

A wireless connection establishment method of the subscriber station 100 will now be described based on the above-described structure.

Hereinafter, the service specific convergence sublayer is called a “CS layer” and other layers in the MAC layer L2, excluding the CS layer, will be called a “MAC layer” for better comprehension and ease of description.

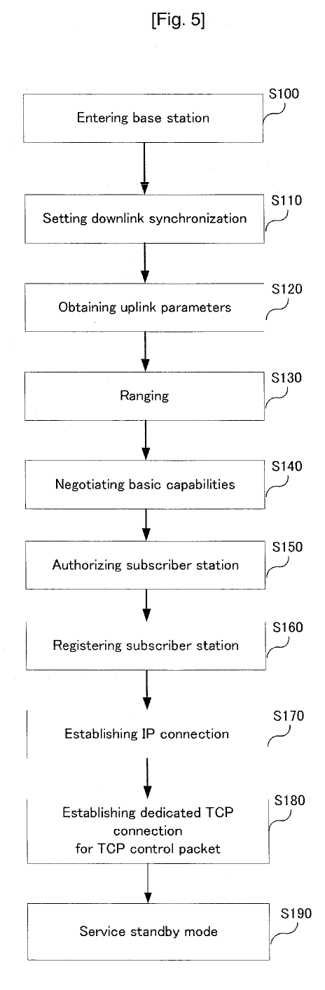

FIG. 5 is a flowchart showing initial connection establishment between a BS and a SS in a wireless portable Internet system.

When the SS 200 enters the BS 100 in step S100, the BS 100 sets downlink synchronization with the SS 100, in step S110. Once the downlink synchronization is set, the SS 200 obtains an uplink parameter in step S120. For example, the parameter includes a channel descriptor message according to characteristics of the physical layer (e.g., signal-to-noise ratio (SNR)).

Ranging is performed between the SS 200 and the BS 100 in step S130. Initial ranging is performed first, and then periodic ranging is performed later such that information on timing and power frequency of the BS 100 and the SS 200 correspond to each other.

When the ranging is terminated, basic capabilities negotiation is performed for establishing a connection between the SS 200 and the BS 100 in step S140. The BS 100 performs authentication on the SS 200 using a device identifier (e.g., MAC address) and a certificate in step S150 when the basic capabilities negotiation is completed.

Once the authentication of the SS 200 is completed and thus the SS 200 is able to access the wireless portable Internet, the base station 100 registers a device address of the SS 200 in step S160, and creates an IP-connection to allocate an IP address to the SS 200, in step S170.

The SS 200 creates a connection for TCP control packet transmission to receive portable Internet services in step S180.

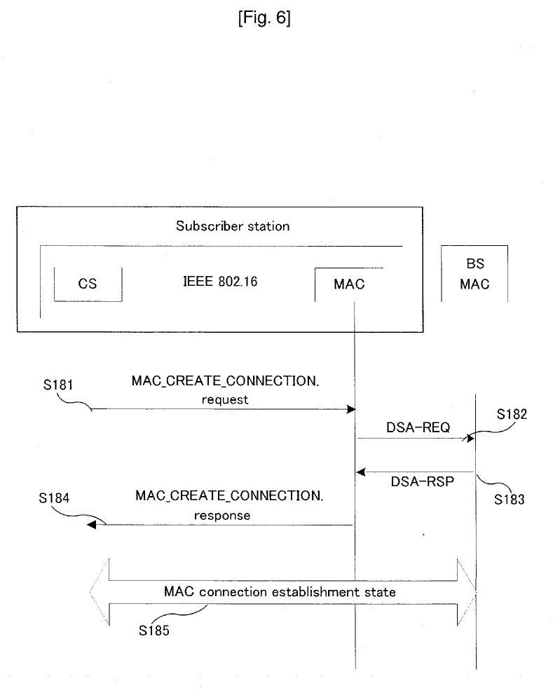

FIG. 6 is a flowchart showing TCP connection establishment according to an exemplary embodiment of the present invention.

The MAC connection processor 213 requests generation of a MAC connection from the MAC layer in order to generate a dedicated TCP connection through which a TCP control packet is transmitted at a future time, and accordingly the MAC layer transmits a request message DSA_REQ for generating a MAC connection to the BS, in steps S181 and S182.

The MAC layer of the BS 100 transmits a response message DSA_RSP as an allowance of the MAC connection establishment with the SS 200 in response to the DSA_REQ in step S183. As described, when receiving the DSA_RSP, the MAC layer informs that the MAC connection is established upon the DSA_REQ to the MAC connection processor 213 of the CS layer L23 in step S184. Then, the MAC connection processor 213 perceives that a given MAC connection is established between the BS 100 and the SS 200, and sets the MAC connection as a dedicated TCP connection for transmitting TCP control packets in step S185.

When the dedicated TCP connection is established, the SS 200 goes into a service standby mode in step S190, as shown in FIG. 5.

A process of establishing a TCP connection using the dedicated TCP connection will be described.

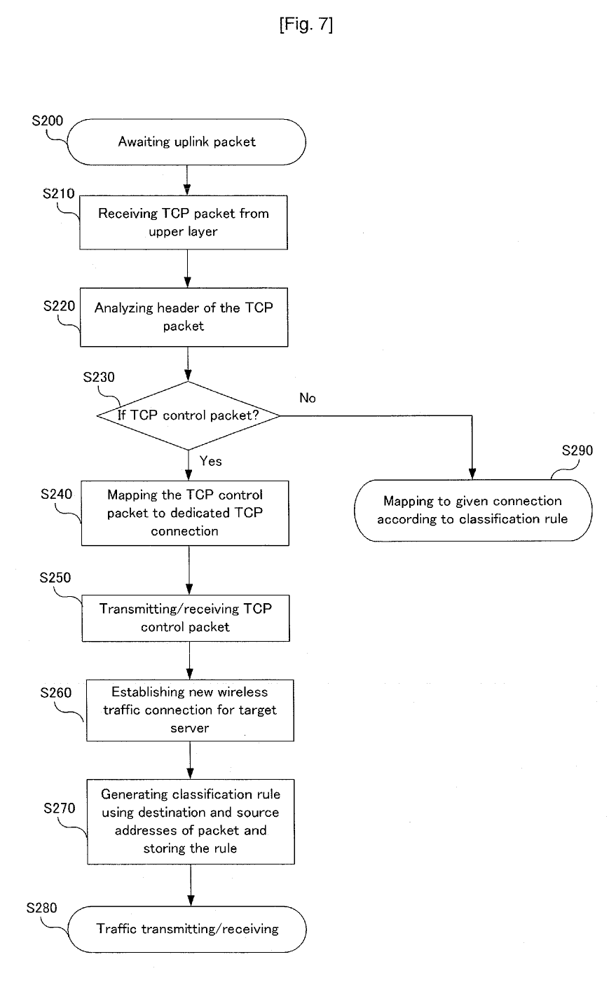

FIG. 7 is a flowchart showing a TCP connection handling process according to an exemplary embodiment of the present invention.

As shown in FIG. 7, when a given packet is transmitted from the TCP/IP layer L3, which is an upper layer, while the SS 200 is in the service standby mode, the packet classifying unit 212 of the CS layer L23 analyzes a header attached to the given packet to identify the type of the packet, and maps the packet to an appropriate connection according to an analyzing result through steps S200 to S220.

In particular, when receiving a TCP packet, the packet classifying unit 212 analyzing a flag field in the packet header to identify the type of the packet. When the received TCP packet corresponds to a TCP control packet (e.g., TCP:SYN, TCP:ACK, TCP:FIN, etc.), the received TCP packet is transmitted to the BS 100 through the dedicated TCP connection, in steps S230 and S240. Since the dedicated TCP connection has been established and activated in advance, the SS 200 does not need to request a radio resource to establish a connection for the TCP control packet from the BS 100. In particular, since channel access is contention-based in the context of an OFDM-based wireless portable Internet service, a delay may occur in responding to a radio access request for transmitting/receiving packets. On the contrary, the TCP control packet is transmitted through the dedicated TCP connection established in advance, and accordingly, packet transmission speed becomes relatively fast according to the embodiment of the present invention. Thus, TCP control speed becomes enhanced by virtue of fast packet transmission.

In step S240, all the TCP control packets are processed through a given process and transmitted to a predetermined terminal node, which is the server 400 for providing Internet services, through the dedicated TCP connection via the BS without regarding destination addresses and port numbers of the respective TCP control packets. Since the dedicated TCP connection supports an uplink and downlink, a TCP control packet is transmitted to the SS 200 from the BS 100 in the same manner as it is transmitted from the SS 200 to the BS 100, in step S250.

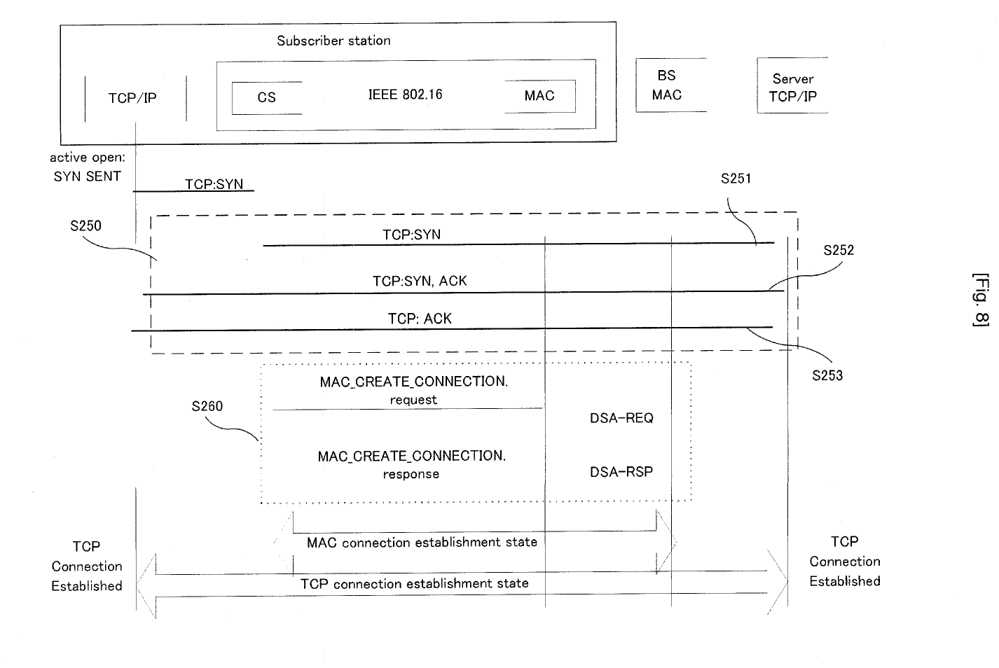

FIG. 8 is a flowchart showing a TCP connection and a process of establishing a wireless connection according to an exemplary embodiment of the present invention.

As shown in FIG. 8, when a new TCP connection is established and traffic transmission is performed, a control packet TCP:SYN is transmitted from an upper layer L3 of the MAC layer, and the packet classifying unit 212 of the CS layer L23 transmits the TCP:SYN packet to the BS 100 through the dedicated TCP connection. The control packet is then transmitted to a server 400 at the corresponding destination address according to a control of the BS, in step S251. The server 400 transmits a response control packet TCP:SYN:ACK to the TCP/IP layer L3 through the MAC layer L2 and the CS layer L23 of the SS 200 in response to the TCP:SYN packet, in step S252. When a TCP:ACK packet is transmitted from the TCP/IP layer in response to the TCP:SYN:ACK packet, the packet classifying unit 212 transmits the TCP:ACK packet to the server 400. As a result, a TCP connection is established between the SS 200 and the server 400 in step S253.

Once the TCP connection is established, as shown in FIG. 8, a process for establishing a wireless MAC connection is performed for traffic transmission with the server 400, and as a result a new MAC connection is established in step 260.

As described above, once the TCP connection is established between the SS 200 and the server 400 as shown in FIG. 7, the packet classifying unit 212 extracts information included in the header of the TCP:SYN:ACK packet, generates a new rule for classifying packets, and stores the new rule in the classification rule database D1 in step S270, the information containing a destination address and a source address. For example, the packet classifying unit 212 maps an ID number of the MAC connection generated in step S400 with respect to the destination address and the source address, and stores a mapping result. After the mapping is finished, packets associated with the destination address and the source address are transmitted/received through the MAC connection. The foregoing process is performed when a MAC connection is established for each PTC connection, and accordingly an ID number for each MAC connection is stored, wherein each MAC connection has been established corresponding to a destination address and a source address contained in a header of a packet transmitted through each TCP connection.

Later, a wireless MAC connection and a TCP connection are created between the SS 200 and the server 400, and accordingly, the server 400 performs traffic transmitting/receiving in step S280. In other words, when the SS 200 sends an HTTP request for a file, the server 400 downloads the appropriate file as an HTTP response.

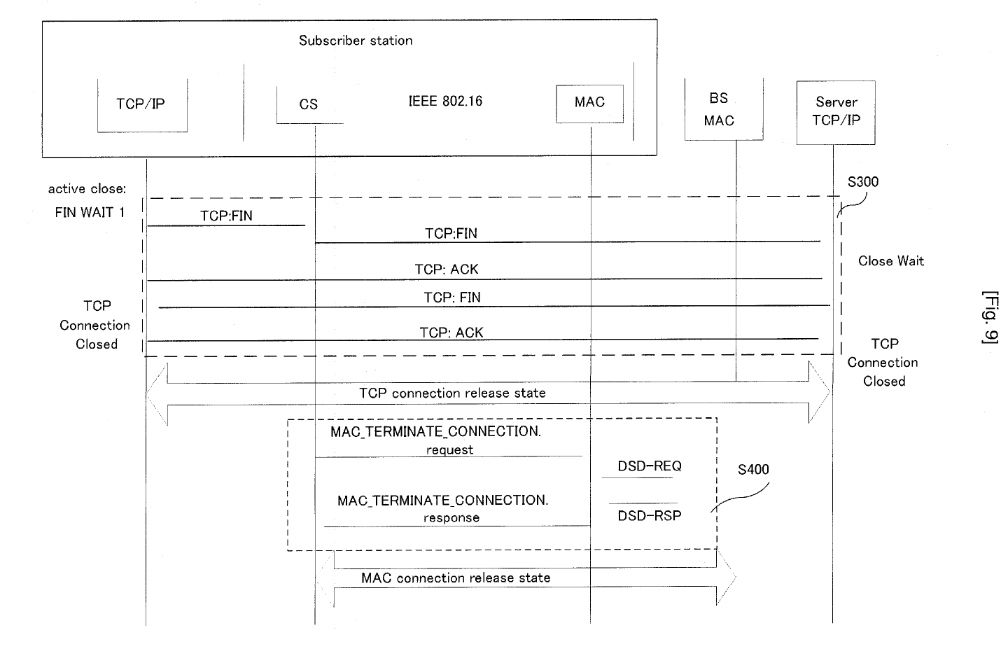

Once file transmission is completed, a process for releasing an associated TCP connection and wireless connection is performed as shown in FIG. 9. FIG. 9 shows a process of releasing a TCP connection and a wireless connection according to an exemplary embodiment of the present invention. As shown in FIG. 9, when a TCP:FIN packet is transmitted to the server 400 and the subscriber station 200 receives a TCP:ACK packet from the server 400, a TCP connection established between the subscriber station 200 and the server 400 is released in step S300. Then, the MAC layer of the subscriber station 200 and the MAC layer of the server 400 transmit/receive messages DSD-REQ and DSD-RSP, and accordingly, the MAC connection is released in S400. As described, a process for establishing a TCP connection and a wireless connection is performed when file transmission is performed, and a process for releasing the associated TCP connection and wireless connection is performed when the file transmission is completed.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method for establishing a wireless connection performed by a subscriber station to receive Internet services from a given terminal node through a base station, the method comprising:
a) when an initial connection with the base station is established, establishing a first medium access control (MAC) connection between the base station, and setting the first MAC connection as a dedicated connection;
b) when a given packet is generated, the subscriber station determining whether the given packet is a control packet for transmission Control Protocol (TCP) connection with the terminal node;
c) when the given packet is the control packet, transmitting the given packet through the dedicated TCP connection and establishing a TCP connection with the terminal node;
d) after establishing the TCP connection, establishing a second MAC connection for data communication between the terminal node and the base station; and
e) after establishing the TCP connection and the second MAC connection, receiving data from the terminal node through the second MAC connection.

2. The method of claim 1, further comprising:
extracting a destination address and a source address of the control packet when the TCP connection is established; and
mapping an identification number of the second MAC connection to the destination and source addresses, and generating a packet classification rule,
wherein in e), a packet having the destination and source addresses is transmitted through the second MAC connection.

3. The method of claim 1 or claim 2, further comprising:
when receiving data from the terminal node, the subscriber station transmitting a control packet for releasing a TCP connection through the dedicated TCP connection and releasing a TCP connection established between the subscriber station and the base station; and
releasing the second MAC connection with the base station when the TCP connection is released.

4. The method of claim 1 or claim 2, wherein the dedicated TCP connection is maintained until a connection between the subscriber station and the base station is shut down.

5. A subscriber station establishing a wireless connection to receive Internet services from a base station through a given terminal node in a wireless portable Internet system, the subscriber station comprising:
a Medium Access Control (MAC) connection processing unit establishing a first MAC connection with the base station and setting the connection as a dedicated TCP connection when an initial connection with the base station is established;
a packet generator generating a control packet for a TCP connection with the base station and a response packet in response to a given packet received at the subscriber station; and
a packet classifying unit analyzing a header of a packet transmitted from the packet generator and determining whether the packet is a control packet for a TCP connection, and transmitting the packet to the base station through the dedicated TCP connection when the packet is a control packet.

6. The subscriber station of claim 5, wherein the subscriber station comprises:
a physical layer performing wireless communication functions including modulation/demodulation and coding;
a MAC layer performing a wireless connection, and having a service specific convergence layer classifying and processing a TCP packet;
a Transmission Control Protocol/Internet Protocol (TCP/IP) layer transmitting data using a TCP protocol; and
an application layer including an application program using a network,
wherein the packet classifying unit and the MAC connection processing unit are included in the service specific convergence layer of the MAC layer.

7. The subscriber station of claim 5 or claim 6, wherein the packet classifying unit further comprises a classification rule database storing rules for identifying an identification number of a MAC connection corresponding to a destination address and a source address of a given packet.

8. The subscriber station of claim 7, wherein the packet classifying unit determines a connection corresponding to a destination address of a packet transmitted from the packet generator from the classification rule database, and transmits the packet to the connection after establishing the TCP connection.
